(19) United States
(12) Patent Application Publication
(10) Pub. No.: US 2013/0298077 A1
(43) Pub. Date: Nov. 7, 2013

(54) DISPLAY CONTROL APPARATUS CAPABLE OF PLACING OBJECTS ON SCREEN ACCORDING TO POSITION ATTRIBUTES OF THE OBJECTS, CONTROL METHOD THEREFOR, AND STORAGE MEDIUM

(71) Applicant: CANON KABUSHIKI KAISHA, Tokyo (JP)

(72) Inventor: Yuichiro Hirota, Tokyo (JP)

(73) Assignee: CANON KABUSHIKI KAISHA, Tokyo (JP)

(21) Appl. No.: 13/874,557

(22) Filed: May 1, 2013

(30) Foreign Application Priority Data
May 7, 2012 (JP) 2012-105988

(51) Int. Cl. G06F 3/0481

(52) U.S. Cl. CPC G06F 3/0481
USPC 715/801

(57) ABSTRACT

A display control apparatus which is capable of accurately designating a reference point, which is to be a reference for scaling to a desired one, on a map screen without burdening a user. One or more objects, with which position information is associated, are displayed at positions based on the position information on a map image in a display area. At least one of the one or more objects displayed in the display area is specified as a reference object. When an instruction for enlarging a display range of the map image is received, a display range of the map image after scaling is controlled so that the reference object can be displayed within the display area even after scaling.

### BACKGROUND OF THE INVENTION

1. Field of the Invention

The present invention relates to a display control apparatus for placing and displaying objects on a screen according to position attributes indicating positions of the objects on a map, a control method therefor, and a computer-readable storage medium storing a program for implementing the control method.

2. Description of the Related Art

In general, objects are placed on a screen (for example, a map screen) according to their position attributes. For example, there is known a map application software program for placing thumbnails of images on a map screen based on shooting position attributes of the images.

On the other hand, when an arbitrary position is designated on a map screen, a map is scaled up with the designated position at its center to display a more detailed map screen (see Japanese Laid-Open Patent Publication (Kokai) No. 2011-215532).

Because a map is exponentially scaled up or down, a central position on the enlarged map shifts to a large extent even when a position designated on a map screen by a user is slightly different from a position desired by the user. As a result, a map in a range desired by the user may not be screen-displayed.

For this reason, a position which is to be a reference in enlarging or reducing a map is required to be designated with accuracy. However, when a user designates a position using a mouse or a touch panel, a designation error tends to inevitably occur. It is thus difficult to accurately designate a desired point (position) on a map screen and enlarge or reduce a map so as to display a range desired by a user.

### SUMMARY OF THE INVENTION

The present invention provides a display control apparatus which is capable of accurately designating a reference point, which is to be a reference for scaling as desired, on a map screen without burdening a user, a control method therefor, and a computer-readable storage medium storing a program for implementing the control method.

Accordingly, a first aspect of the present invention provides a display control apparatus which is capable of displaying a part of a map image as a display range of the map image in a display area of a display unit, comprising a receiving unit configured to receive an instruction for scaling the display range of the map image displayed in the display area, a display control unit configured to provide control to display one or more objects, with which position information is associated, at positions based on the position information in the display range of the map image on the display area, and a specifying unit configured to specify at least one of the one or more objects displayed in the display area as a reference object, wherein when the receiving unit receives an instruction for enlarging the display range of the map image, the display control unit controls a display range of the map image after scaling so that the reference object can be displayed within the display area even after scaling.

Accordingly, a second aspect of the present invention provides a method for controlling a display control apparatus which is capable of displaying a part of a map image as a display range of the map image in a display area of a display unit, comprising a display step of displaying one or more objects, with which position information is associated, at positions based on the position information on a map image in a display area, a specifying step of specifying at least one of the one or more objects displayed in the display area as a reference object, a receiving step of receiving an instruction for scaling the map image displayed in the display area, and a control step of, when an instruction for enlarging the display range of the map image is received, controlling a display range of the map image after scaling so that the reference object can be displayed within the display area even after scaling.

Accordingly, a third aspect of the present invention provides a non-transitory computer-readable storage medium storing a program for implementing a control method for controlling a display control apparatus, the control method comprising a display step of displaying one or more objects, with which position information is associated, at positions based on the position information on a map image in a display area, a specifying step of specifying at least one of the one or more objects displayed in the display area as a reference object, a receiving step of receiving an instruction for scaling the map image displayed in the display area, and a control step of, when an instruction for enlarging the display range of the map image is received, controlling a display range of the map image after scaling so that the reference object can be displayed within the display area even after scaling.

According to the present invention, a reference point, which is to be a reference for scaling as desired, can be accurately designated on a map screen without burdening a user.

Further features of the present invention will become apparent from the following description of exemplary embodiments (with reference to the attached drawings).

### BRIEF DESCRIPTION OF THE DRAWINGS

FIG. 1 is a block diagram schematically showing an exemplary arrangement of a map display apparatus which is a display control apparatus according to an embodiment of the present invention.

FIGS. 2A and 2B are views useful in explaining a scaling process carried out by the map display apparatus appearing in FIG. 1, in which FIG. 2A is a view showing an exemplary display range of a map screen, and FIG. 2B is a view showing another exemplary display range of a map screen.

FIG. 3 is a flowchart useful in explaining a scaling process carried out by the map display apparatus appearing in FIG. 1.

FIGS. 4A to 4C are views useful in explaining an enlarging process in a case where there are a plurality of objects in a predetermined area in the map display apparatus appearing in FIG. 1, in which FIG. 4A is a view showing a map screen before the enlarging process, FIG. 4B is a view showing coordinates at which the objects appearing in FIG. 4A are placed, and FIG. 4C is a view showing a map screen after the enlarging process.

FIG. 5 is a view useful in explaining how reference object candidates are clearly specified in the map display apparatus appearing in FIG. 1.

FIGS. 6A and 6B are views useful in explaining an enlarging process in a case where there is no object in a predetermined area in the map display apparatus appearing in FIG. 1, in which FIG. 6A is a view showing a map screen before the enlarging process, and FIG. 6B is a view showing a map screen after the enlarging process.

FIG. 7 is a view useful in explaining an exemplary display produced when an object is selected in the map display apparatus appearing in FIG. 1.

### DESCRIPTION OF THE EMBODIMENTS

A description will now be given of a map display apparatus which is a display control apparatus according to an embodiment of the present invention with reference to the drawings.

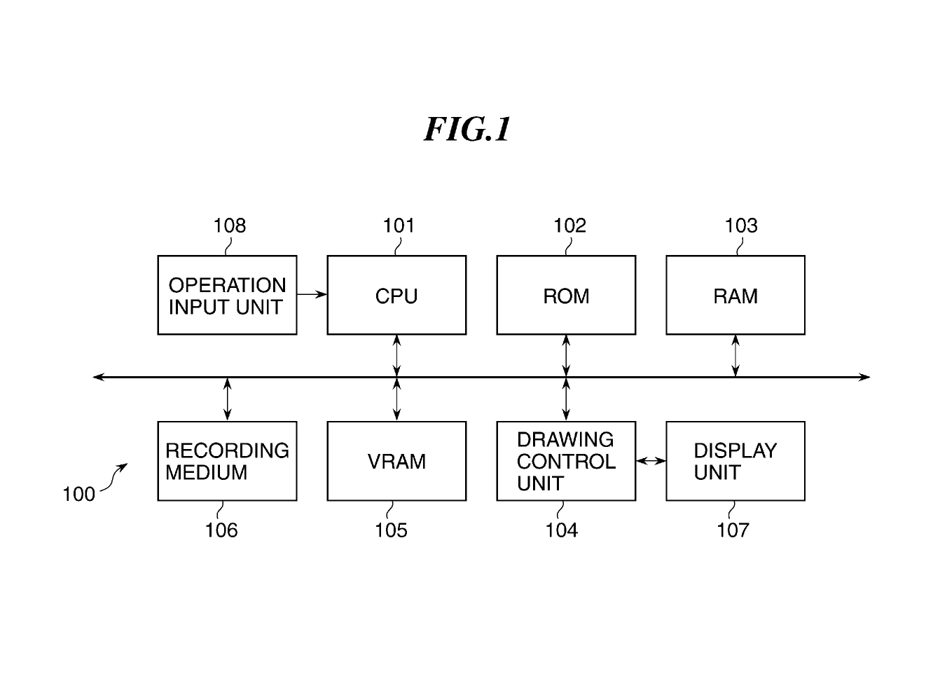

FIG. 1 is a block diagram schematically showing an exemplary arrangement of the map display apparatus which is the display control apparatus according to the embodiment of the present invention.

In the following description of the present embodiment, a personal computer (PC) is taken as an example of the map display apparatus 100 shown in the figure. It should be noted that an apparatus which can be used as the map display apparatus 100 is not limited to a PC. For example, a cellular phone, a so-called tablet device, or the like may be used.

The PC 100 has a CPU 101, which controls the overall operation of the PC 100. In the PC 100 shown in the figure, a program relating to an image map display application, to be described later (hereafter referred to as the map program) is stored in, for example, a recording medium 106. The CPU 101 reads out the map program from the recording medium 106, expands the same on a RAM 103, and executes the same. As a result, the CPU 101 provides map display control in a manner described later.

A ROM 102 is, for example, a rewritable nonvolatile memory, and control programs for controlling the PC 100 and information such as setting parameters required for operation of the PC 100 are stored in the ROM 102. The RAM 103 is a volatile memory, which is not only used as an expansion area for the map program but also used as a temporary storage area for intermediate data generated during operation of the PC 100.

A drawing control unit 104 generates a display image which is to be displayed on a display unit 107 and controls output of the display image to the display unit 107. The drawing control unit 104 reads out objects such as GUIs (graphic user interfaces), which are stored in the ROM 102 or the recording medium 106, under the control of the CPU 101. The drawing control unit 104 places the objects at predetermined positions on a display image in a VRAM 105 in which the display image is stored. It should be noted that the VRAM 105 is a storage area for drawing, in which a display image is stored.

The recording medium 106 is, for example, a recording device, such as an HDD or a memory card, which can be attached to and removed from the PC 100 and in which the map program is recorded as described earlier, and also, objects to be placed on an image representing a map are recorded.

It should be noted that in the present embodiment, it is assumed that the map program and objects to be placed on maps are recorded in the recording medium 106, but the map program and the objects may be obtained from, for example, a server on a network such as the Internet via a network interface (not shown). The objects are GUIs, which are, for example, graphical data such as icon and thumbnail images.

The display unit 107 is a display device such as a liquid crystal monitor. It is assumed here that the display unit 107 is incorporated in the PC 100, but the display unit 107 may be an external display device connected to the PC 100.

An operation input unit 108 receives an operation performed by a user via a user interface such as a mouse or a keyboard connected to the PC 100. The operation input unit 108 sends a control signal corresponding to the operation to the CPU 101. Here, for example, the user issues an instruction to scale a map by operating the user interface as necessary while viewing a plurality of objects and a map screen (also referred to merely as a map) displayed on the display unit 107.

In the following description, it is assumed that the user clicks an enlargement button or a reduction button on a map by operating the mouse, but for example, the user may issue an instruction to scale a map by operating dedicated buttons or a touch operation using a touch sensor (touch panel) which is provided on the display unit 107.

Assume now that in the map display apparatus 100 appearing in FIG. 1, a number of contents to be displayed, image files here, are ready to be accessed by the user. It should be noted that the image files may be recorded in the HDD or may be recorded in an external device accessible via a network. Further, the map display apparatus 100 may take subject images to generate image files and record them in the HDD. Namely, the map display apparatus 100 itself may be configured to generate image files to be displayed. In this case, the map display apparatus 100 is further equipped with a position obtainment unit that obtains position information so as to record the position information in image files. A GPS receiver, for example, may be used as the position obtainment unit.

When an image display application stored in the HDD is started, the CPU 101 carries out a process described hereafter in accordance with this program stored in the HDD. A description will now be given of a zooming reference point selection process carried out by the image display application.

Here, a “reference point for zooming” is defined in a case where “a map is scaled up (zoomed in) with a position P at its center” and a case where “a map is scaled down (zoomed out) with a position P at its center”.

The reference point for zooming means such a position that the correspondence between coordinates on a map screen and a position (latitude and longitude) represented by the coordinates does not change before and after zooming.

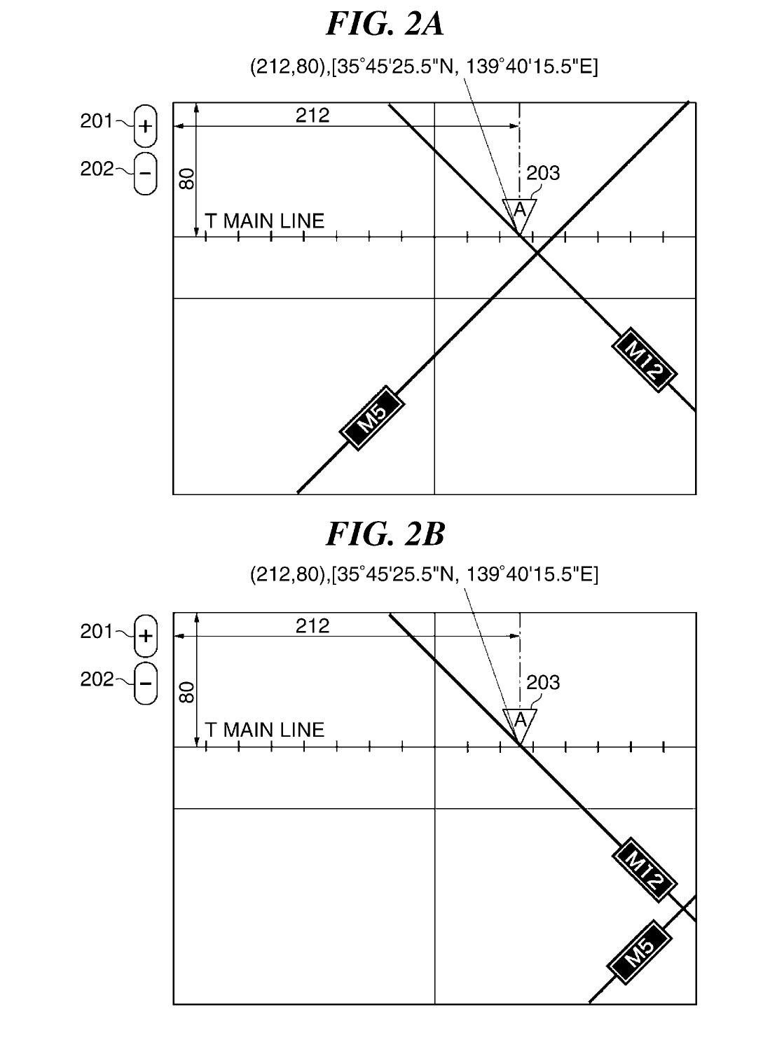

FIGS. 2A and 2B are views useful in explaining a scaling process carried out by the map display apparatus 100 appearing in FIG. 1, in which FIG. 2A is a view showing an exemplary display range of a map screen, and FIG. 2B is a view showing another exemplary display range of a map screen.

Referring to FIG. 2A, a map screen is displayed on the display unit 107, and an enlargement button 201 and a reduction button 202 are displayed on this map screen. An object A indicative of the presence of an image file is also displayed on the map screen. The object A has a position attribute “35 degrees 45 minutes 25.5 seconds north latitude and 139 degrees 40 minutes 15.5 seconds east longitude” and is indicated by an icon 203 on the map screen. The icon 203 is placed on the map screen such that a tip thereof points the position attribute on the map screen.

Coordinates at which the icon 203 is to be placed on a map screen are determined by a display range of the present map screen. A display range of a map screen can freely be set trough a drag operation or the like by the user. Namely, a display range of a map screen is part of the entire map image.

Assume now that a display range of a map screen at a given moment is as shown in FIG. 2A. In this case, the icon 203 is placed on a map such that the tip thereof overlays coordinates (212, 80) corresponding to the position attribute of the object A in the display range of the present map screen.

In this state, when the map is enlarged with a position which the position attribute of the object A indicates at its center, the map is brought into a state shown in FIG. 2B. In the state shown in FIG. 2B, the map is scaled up in response to the enlarging operation, but in both FIGS. 2A and 2B, the coordinate point corresponding to the central position [35 degrees 45 minutes 25.5 seconds north latitude and 139 degrees 40 minutes 15.5 seconds east longitude] is (212, 80), which does not charge before and after the enlarging operation.

Here, this enlarging operation is expressed as “the enlarging operation is performed with the position of the object A [35 degrees 45 minutes 25.5 seconds north latitude and 139 degrees 40 minutes 15.5 seconds east longitude] at its center”.

It should be noted that although in the examples shown in FIGS. 2A and 2B, a triangular icon pointing downward is used as the icon 203 indicative of an object, various icons indicative of objects may be used according to applications. For example, when an object is photographic image data, a thumbnail image of the photographic image data may be disposed such that a center thereof overlays a point in a display range of a map screen which corresponds to a shooting position attribute of the photographic image data.

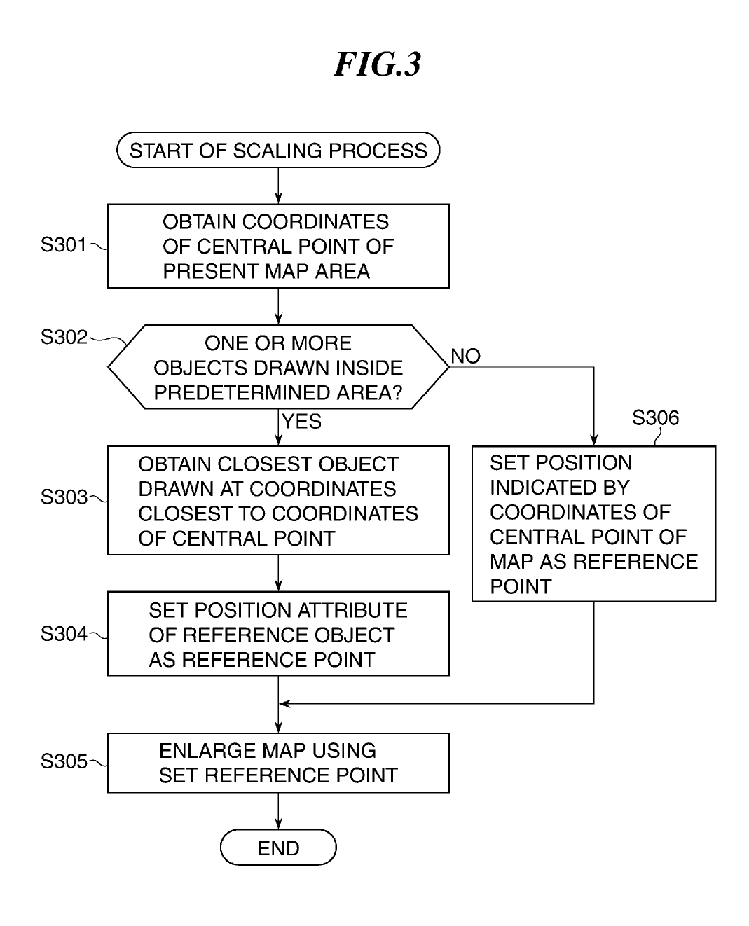

FIG. 3 is a flowchart useful in explaining a scaling process carried out by the map display apparatus 100 appearing in FIG. 1. It should be noted that the scaling process includes an enlarging process and a reducing process, but in the following description, the enlarging process is taken as an example of the scaling process, and description of the reducing process is omitted because it is similar to the enlarging process.

Assuming now that the user clicks the enlargement button 201 displayed on a map screen, the CPU 101 detects the click and starts the scaling process for a map displayed on the display unit 107. It should be noted that when the user clicks the reduction button 202, the CPU 101 starts the scaling process in the same way.

First, the CPU 101 obtains, from the drawing control unit 104, coordinates of a central point in a display range of the present map screen (step S301). The coordinates of this central point are determined by the width and height of the map screen.

Next, the CPU 101 determines whether or not there are one or more objects drawn inside a predetermined area on the present map screen (step S302). The predetermined area means an area including a central point of the map and satisfying predetermined conditions.

It should be noted that the predetermined area may have any shape as long as it is a closed area including a central point on a map screen. Examples of the predetermined area include an area enclosed by a circle having a predetermined radius with the central point at its center, an area enclosed by an ellipse having a predetermined long diameter or short diameter in a vertical direction and a horizontal direction with the central point at its center, and an area enclosed by a rectangle having a predetermined line of intersection with the central point at an intersection. Whether or not an object is included in the predetermined area is determined by comparing coordinates of the object and coordinates of the predetermined area, and there are a variety of determination algorithms therefor, but detailed description thereof is emitted here.

When there are one or more objects inside the predetermined area (YES in the step S302), the CPU 101 determines that the user is interested in any object within the predetermined area, refers to coordinates at which objects are displayed inside the predetermined area, and obtains, as a reference object, an object placed closest from the central point of the map (step S303).

Then, the CPU 101 sets coordinates in the display range of the map screen, which correspond to a position attribute of the reference object, as a reference point for the scaling process (step S304). Namely, the CPU 101 determines that the user is interested in this reference object and its vicinity. Then, the CPU 101 carries out the map scaling process (here, the enlarging process) using the set reference point as a center (step S305) and terminates the scaling process.

When there are no objects inside the predetermined area (NO in the step S302), the CPU 101 determines that the user is not interested in any objects on the map but is interested in an area itself in the vicinity of the center of the currently displayed map, and sets a position indicated by the coordinates of the central point of the map as a reference point for the scaling process (step S306). The CPU 101 then proceeds to the process in step S305.

It should be noted that the process in the step S302 described above is carried out on the assumption that there may be cases where the user is not interested in any objects on the map. When it is assumed that the user is always interested in any object, the process in the step S303 should be carried out without setting the predetermined area described above.

A description will now be given of a case where a zooming operation is performed when there are a plurality of objects in the predetermined area. In the following description, it is assumed that the enlarging process is carried out, but the same holds for the reducing process.

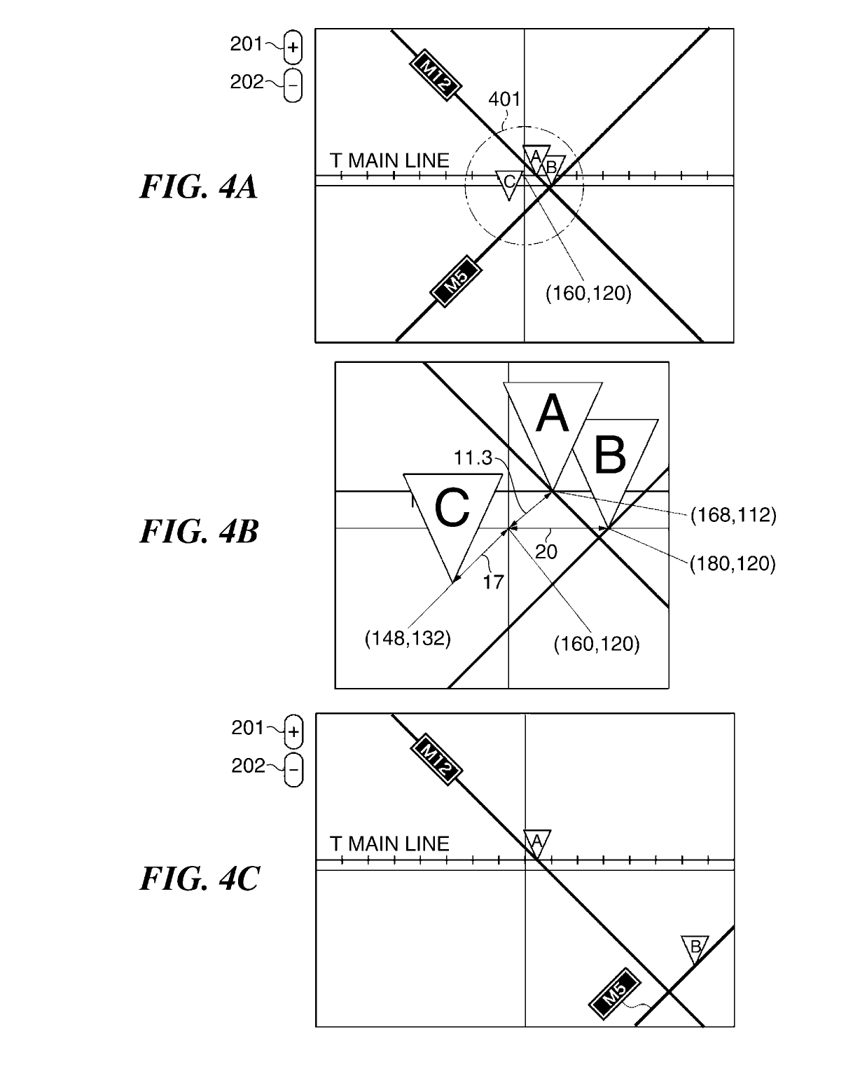

FIGS. 4A to 4C are views useful in explaining an enlarging process carried out in a case where there are a plurality of objects in the predetermined area in the map display apparatus 100 appearing in FIG. 1, in which FIG. 4A is a view showing a map screen before the enlarging process, FIG. 4B is a view showing coordinates at which the plurality of objects appearing in FIG. 4A are placed, and FIG. 4C is a view showing a map screen after the enlarging process.

A map screen shown in FIG. 4A is displayed on the display unit 107. In FIG. 4A, there are objects A to C in the predetermined area. Coordinates at which the objects A to C are placed are as shown in FIG. 4B.

Here, as described above with reference to FIG. 3, when the enlargement button 201 appearing in FIG. 4A is clicked, the CPU 101 obtains coordinates of a central point (160, 120) in a display range of the present map screen in the step S301.

Then, in the step S302, the CPU 101 determines whether or not there are one or more objects drawn inside a circle 401 which is the predetermined area. In the example shown in FIG. 4A, there are the objects A, B, and C inside the circle 401, and hence the CPU 101 determines that there are one or more objects drawn inside the circle 401.

In the step S303, the CPU 101 obtains distances between coordinates at which the objects A to C are placed and the coordinates of the central point. As shown in FIG. 4B, the distance between the object A and the central point is “11.3”, the distance between the object B and the central point is “20”, the distance between the object C and the central point is “17”. Thus, the CPU 101 obtains the object A, whose distance from the central point is the shortest, as a reference object. Then, in the step S304, the CPU 101 sets coordinates (168, 112), at which the object A is placed, as a reference point.

In the step S305, the CPU 101 carries out the scaling process using the set reference point to perform an update from the map screen shown in FIG. 4A to a map screen shown in FIG. 4C and causes the drawing control unit 104 to display the update map screen on the display unit 107. Specifically, the CPU 101 reads out a map image on a changed scale from the recording medium 106, extracts an area with a display size of the map screen with the reference point at its center, draws the area on the map screen, and displays the map screen on the display unit 107. As a result, the user can see the object A and its vicinity in which he or she is interested.

In the scaling process carried out in the case where there are a plurality of objects in the predetermined area, a reference object is obtained in the above described manner. In this case, particularly when a plurality of objects are dense, it is difficult for the user to identify an object, which is to be a reference point, on a map screen at a glance. It is thus preferable that an object which is to be a reference point is clearly specified for the user in advance.

Here, upon receiving a notification of an event such as hovering a cursor over something, the CPU 101 carries out the process in the step S304 in which it sets a reference point. As a result, the CPU 101 determines which object is to be a reference point when the enlargement button is clicked in the present state, selects the object as a reference object candidate, and clearly specifies the same on the display unit 107.

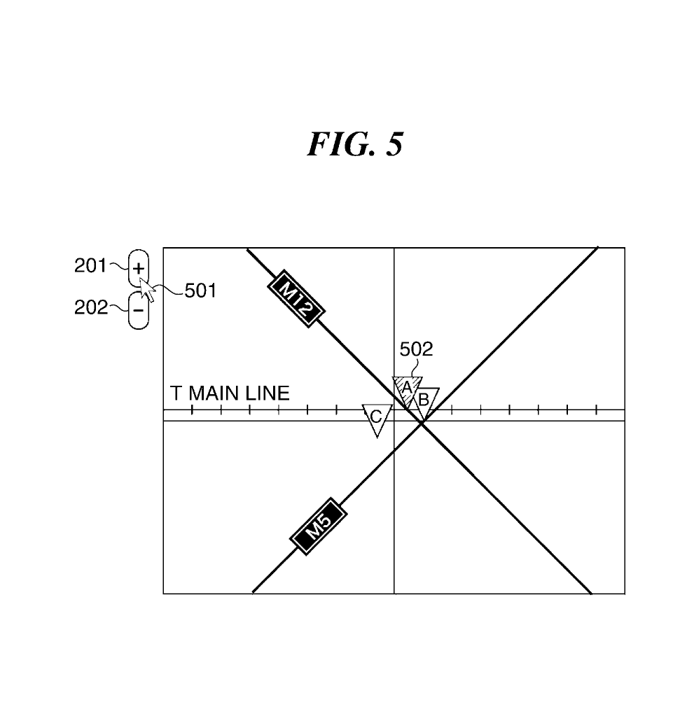

FIG. 5 is a view useful in explaining how reference object candidates are clearly specified in the map display apparatus 100 appearing in FIG. 1. It should be noted that in the example shown in FIG. 5, objects A to C are placed in the same arrangement as in the example shown in FIG. 4A.

Assuming now that in response to a user's operation, the CPU 101 detects a cursor 501 hovering over the enlargement button 201, the object A becomes a reference object candidate as a result of the process described above with reference to FIG. 3. As a result, the CPU 101 clearly specifies the object A as a reference object candidate 502 distinctively from the other objects B and C.

Although it is assumed here that when a cursor hovering over a scaling button is detected, a reference object candidate is clearly specified, a reference object candidate may be clearly specified in a manner described hereafter. (1) A reference object candidate is always clearly specified distinctively from other candidates irrespective of whether or not an event such as a cursor hovering over a scaling button has occurred. (2) When a finger being put on a scaling button is electrically or mechanically detected in a case where the scaling button is a physical button, a reference object candidate is always clearly specified distinctively from other candidates.

As described above, there are a variety of triggers or timings for clearly specifying a reference object candidate, and an appropriate technique should be selected according to characteristics of devices and applications.

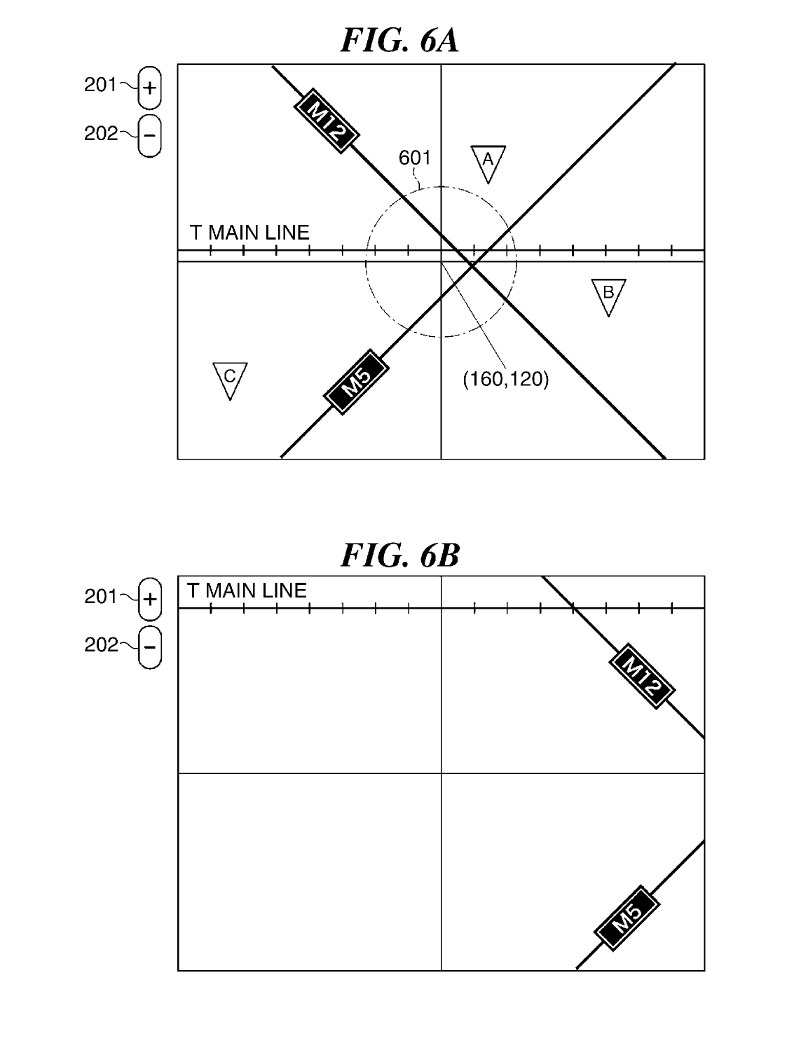

FIGS. 6A and 6B are views useful in explaining an enlarging process carried out in a case where there is no object in a predetermined area in a display range of a map screen in the map display apparatus 100 appearing in FIG. 1, in which FIG. 6A is a view showing a map screen before the enlarging process, and FIG. 6B is a view showing a map screen after the enlarging process.

When the enlargement button 201 is clicked in the state shown in FIG. 6A, the CPU 101 obtains coordinates (160, 120) of a central point in a display range of the present map screen in the step S301. Then, in the step S302, the CPU 101 determines whether or not there are one or more objects inside a predetermined area 601.

In the example shown in FIG. 6A, there is no object inside the predetermined area 601, and hence in the step S306, the CPU 101 sets the coordinates of the central point (160, 120) in the display range of the present map screen as a reference point. Then, by controlling the drawing control unit 104, the CPU 101 carries out a scaling process (here, an enlarging process) using the reference point to display the map screen shown in FIG. 6B on the display unit 107.

In the above described way, when there is no object inside the predetermined area 601, it is determined that the user is interested in an area in the vicinity of a center of a currently displayed map, not objects on the map, and the area in the vicinity of the center of the map is zoomed in.

As described above, according to the present embodiment, when there are objects on a map, a coordinate point in a display range of a map screen which corresponds to a position attribute of an object closest to a central point is set as a reference point. When there are no objects on the map, a coordinate point of the central point in the display range of the map screen is set as a reference point, and the map is scaled up or down using this reference point. Therefore, when the user is to scale up or down a map on which a plurality of objects are placed, a desired display range can be precisely displayed without burdening the user.

It should be noted that in the above description of the present embodiment, scaling is performed by using a center of a map screen as a reference and extracting an area based on a position of an object placed in the center of the map screen or closest to the center of the map screen. However, in place of the center, another position may be used as a reference. For example, scaling may be performed by using an upper left corner of a map screen as a reference and extracting an area based on a position of an object placed at the upper left corner of the map screen or closest to the upper left corner of the map screen. Namely, a reference on a map screen may be a predetermined position set in advance.

Moreover, although in the above description of the present embodiment, an instruction to perform scaling is input by selecting an enlargement button or a reduction button using the mouse included in the operation input unit 108, an instruction to perform scaling may be input through an input from a mouse wheel. Namely, the operation input unit 108 receives an instruction to perform scaling by receiving an input from the mouse wheel. When an instruction to perform scaling through an input from the mouse wheel is thus received, an object closest to a center of a screen is not used as a reference object, but an object closest to a position of a mouse cursor is determined as a reference object in a reference point selection process.

Moreover, as described above, an instruction to perform scaling may be input through an input to the touch panel included in the operation input unit 108. For example, an instruction to perform scaling may be input through a so-called double tapping operation in which the touch panel is quickly touched twice. In this case as well, as with the mouse wheel, a reference object is determined in a reference point selection process based on a position of a contact at which the touch panel is touched. As a result, display can be controlled as intended by the user.

Further, by selecting an object displayed on a map using a mouse, a touch panel, or the like, the object may be brought into a selected state. For example, an ordinary map application enables the user to select an object which he or she would like to focus attention on, so that a menu for viewing detailed information on the object is displayed, and a variety of processes for the selected object are carried out.

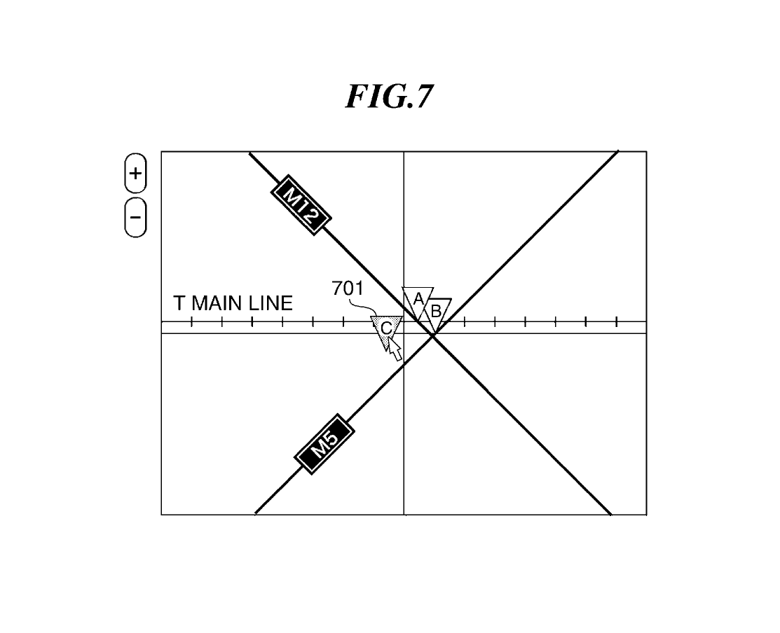

FIG. 7 is a view showing an exemplary display produced when an object C 701 is brought into a selected state by selecting the object C 701 using a mouse. Thus, an object in a selected state is an object on which the user is focusing attention, and preferably, is used as a reference object in scaling. Therefore, when any of displayed objects is in a selected state among the displayed objects, it may be determined that the object in the selected state is a reference object.

For example, when an instruction to perform scaling is received in the state shown in FIG. 7, the CPU 101 determines a display range of a map after scaling using the position of the object C as a reference (that is, using the object C as a reference object). It should be noted that when an instruction to perform scaling is received in a state in which there is no object in a selected state, the same process as that in the embodiment described above is carried out.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-105988 filed May 7, 2012, which is hereby incorporated by reference herein in its entirety.

What is claimed is:

1. A display control apparatus which is capable of displaying a part of a map image as a display range of the map image in a display area of a display unit, comprising:
a receiving unit configured to receive an instruction for scaling the display range of the map image displayed in the display area;
a display control unit configured to provide control to display one or more objects, with which position information is associated, at positions based on the position information in the display range of the map image on the display area; and
a specifying unit configured to specify at least one of the one or more objects displayed in the display area as a reference object,
wherein when said receiving unit receives an instruction for enlarging the display range of the map image, said display control unit controls a display range of the map image after scaling so that the reference object can be displayed within the display area even after scaling.

2. A display control apparatus according to claim 1, wherein said specifying unit specifies, as the reference object, an object displayed at a position closest to a predetermined position in the display area among the one or more objects.

3. A display control apparatus according to claim 2, wherein when the one or more objects are not displayed in a predetermined range based on the predetermined position in the display area, said specifying unit does not specify the reference object.

4. A display control apparatus according to claim 2, wherein the predetermined position is a central position of the display area.

5. A display control apparatus according to claim 1, wherein said receiving unit includes a mouse.

6. A display control apparatus according to claim 1, wherein said receiving unit includes a touch panel.

7. A display control apparatus according to claim 1, wherein when said receiving unit receives the instruction for scaling the display range of the map image, said display control unit controls a display range of the map image after scaling based on positional information on the reference object so that the reference object can be displayed within the display range even after scaling.

8. A display control apparatus according to claim 1, wherein when said receiving unit receives the instruction for scaling the display range of the map image, said display control unit controls a display range of the map image after scaling based on a position at which the reference object is displayed so that the reference object can be displayed within the display range even after scaling.

9. A display control apparatus according to claim 1, further comprising;
an icon display unit configured to display an icon that receives the instruction to perform scaling; and
a second receiving unit configured to receive an instruction for scaling the display range of the map image by selecting the icon,
wherein when said second receiving unit receives the instruction for scaling the display range of the map image, said display control unit determines a display range of the map image after scaling by referring to a central position of the display area as a reference irrespective of a position at which the one or more objects are displayed.

10. A display control apparatus according to claim 1, wherein said display control unit displays the reference object distinctively from other objects.

11. A display control apparatus according to claim 1, wherein the positional information associated with the one or more objects includes information on latitude and longitude.

12. A method for controlling a display control apparatus which is capable of displaying a part of a map image as a display range of the map image in a display area of a display unit, comprising:
a display step of displaying one or more objects, with which position information is associated, at positions based on the position information on a map image in a display area;
a specifying step of specifying at least one of the one or more objects displayed in the display area as a reference object;
a receiving step of receiving an instruction for scaling the map image displayed in the display area; and
a control step of, when an instruction for enlarging the display range of the map image is received, controlling a display range of the map image after scaling so that the reference object can be displayed within the display area even after scaling.

13. A non-transitory computer-readable storage medium storing a program for implementing a control method for controlling a display control apparatus, the control method comprising:
a display step of displaying one or more objects, with which position information is associated, at positions based on the position information on a map image in a display area;
a specifying step of specifying at least one of the one or more objects displayed in the display area as a reference object;
a receiving step of receiving an instruction for scaling the map image displayed in the display area; and
a control step of, when an instruction for enlarging the display range of the map image is received, controlling a display range of the map image after scaling so that the reference object can be displayed within the display area even after scaling.
